(19) United States
(12) Patent Application Publication
(10) Pub. No.: US 2024/0050944 A1
(43) Pub. Date: Feb. 15, 2024

(54) MICROFLUIDIC CASSETTE

(71) Applicant: QuantuMDx Group Limited, Newcastle Upon Tyne, Tyne and Wear (GB)

(72) Inventors: Robin Page, Newcastle Upon Tyne, Tyne and Wear (GB); Michael Whitaker, Newcastle Upon Tyne, Tyne and Wear (GB)

(21) Appl. No.: 18/546,223

(22) PCT Filed: Feb. 11, 2022
(86) PCT No.: PCT/GB2022/050370

§ 371 Date: Aug. 11, 2023

(30) Foreign Application Priority Data
Feb. 12, 2021 (GB) 2102018.5

(51) Int. Cl. B01L 3/00; F16K 99/00

(52) U.S. Cl. CPC B01L 3/502715; F16K 99/003; B01L 3/502738; B01L 2300/0672; B01L 2300/044; B01L 2200/16; B01L 2200/04; B01L 2400/0683; B01L 2200/025

(57) ABSTRACT

A microfluidic cassette has a microfluidic cassette body. The microfluidic cassette body has a fluid flow channel, a first piercing member comprising a wall extending out from the microfluidic cassette body, the wall enclosing a first fluid aperture that is in fluid communication with the fluid flow channel, and a second piercing member comprising a wall extending out from the microfluidic cassette body adjacent to the first piercing member, the wall enclosing a second fluid aperture that is in fluid communication with the fluid flow channel. The first piercing member has a further fluid aperture located on a portion of the wall of the first piercing member facing away from the second piercing member.

### TECHNICAL FIELD

The present invention relates to microfluidic cassettes and associated microfluidic diagnostic systems that use such cassettes.

### BACKGROUND

Microfluidic diagnostic devices are used to provide rapid point of care diagnosis of health conditions based on fluid samples provided by a patient. Microfluidic diagnostic devices comprise components that enable them to interact with and perform diagnostic tests on a fluid sample contained within a microfluidic cassette.

Microfluidic cassettes typically include a plurality of fluid flow channels that allow a fluid sample provided by a patient to pass through the cassette and interact with various reagents contained within the cassette. Such microfluidic cassettes typically include imaging/sensing regions where a microfluidic diagnostic device can perform imaging and/or sensing on the fluid sample within the cassette.

To help ensure accurate and reliable results from the microfluidic diagnostic device, it is desirable for reagents within the cassette to be maintained in satisfactory condition away from moisture and other contaminants. Moisture can be a problem when dried or wet reagents are used. However, moisture is a particular problem when lyophilised reagents are used because such reagents are hydrophilic. This means that even small amounts of moisture can interact with and potentially reduce the effectiveness of such reagents.

It is known to deposit reagents directly onto a fluid flow channel of a microfluidic cassette during manufacturing of the cassette. However, in this arrangement, even if the microfluidic cassette is sealed during manufacture, moisture from the atmosphere or vapour arising from fluids deliberately stored in the cassette can contact and degrade the reagent over time. This can reduce the effectiveness of diagnostic tests performed using the cassette and/or reduce the storage life of the cassette.

WO2020109797A1 discloses a microfluidic cassette arrangement that includes an insert comprising a reagent-containing chamber. The reagent-containing chamber is sealed by a layer of foil. The seal is breakable in situ in the cassette as the insert is forced into contact with a seal breaking structure of the microfluidic cassette. Part of the cassette next to the seal breaking structure is in fluid communication with the fluid flow channel of the cassette such that when the seal of the reagent-containing chamber is broken, fluid can flow from the fluid flow channel of the cassette and into the reagent-containing chamber.

This arrangement allows reagent to remain in a sealed chamber until it is used, thus preventing external materials from contacting and potentially degrading the reagent.

However, in certain conditions of use, this arrangement can result in less regular and controllable flow of a fluid sample through a microfluidic cassette and less complete mixing of a fluid sample with reagent.

For example, in certain conditions, after being broken in situ in the cassette, the foil seal of the reagent-containing chamber can partially occlude the seal breaking structure. This can be caused by reagent in the chamber becoming compacted behind the foil seal. If the foil seal partially occludes the seal breaking structure, this can reduce the rate of fluid flow through the cassette and reduce the degree of mixing of the fluid sample with the reagent. This reduced rate of flow can cause a build-up of pressure behind the fluid sample as the fluid sample is forced through the cassette. Where dried reagents are used in the chamber, this build up in pressure can be suddenly released when the reagent is rehydrated. This sudden release of pressure can result in loss of control and break-up of the fluid sample.

It is an object of certain embodiments of the invention to provide a microfluidic cassette arrangement that obviates or mitigates one or more of the above-described disadvantages.

### SUMMARY OF THE INVENTION

In accordance with a first aspect of the invention there is provided a microfluidic cassette comprising: a microfluidic cassette body. The microfluidic cassette body comprises: a fluid flow channel; a first piercing member comprising a wall extending out from the microfluidic cassette body, the wall enclosing a first fluid aperture that is in fluid communication with the fluid flow channel; and a second piercing member comprising a wall extending out from the microfluidic cassette body adjacent to the first piercing member, the wall enclosing a second fluid aperture that is in fluid communication with the fluid flow channel. The first piercing member comprises a further fluid aperture located on a portion of the wall of the first piercing member facing away from the second piercing member.

Optionally, the further fluid aperture is a slot in the wall of the first piercing member.

Optionally, the slot extends through the wall in a direction from a distal end of the wall towards a proximal end of the wall.

Optionally, the slot is substantially V-shaped and decreases in width in a direction from the distal end of the wall towards the proximal end of the wall.

Optionally, the further fluid aperture is located on the wall at or close to a portion of the wall that extends furthest from the microfluidic cassette body.

Optionally, the wall of the first piercing member and/or the wall of the second piercing member is substantially annular.

Optionally, the distal end of the wall of the first piercing member and/or the distal end of the wall of the second piercing member is substantially sloped.

Optionally, the microfluidic cassette further comprises an insert comprising a reagent-containing chamber, wherein the reagent-containing chamber comprises a seal pierceable by the first and second piercing members.

Optionally, the insert is secured within the microfluidic cassette body and is movable from a first position within the microfluidic cassette body where the seal of the reagent-containing chamber is not in contact with the first and second piercing members to a second position within the microfluidic cassette body where the seal is in contact with the first and second piercing members.

Optionally, the microfluidic cassette body further comprises an outer wall enclosing the first and second piercing members, the outer wall shaped to guide movement of the insert between the first position and the second position.

Optionally, the microfluidic cassette further comprises a cover element arranged to provide a sealed chamber enclosing the first and second piercing member and the insert.

Optionally, the insert is secured to an inner surface of the cover element.

Optionally, the second piercing member comprises a further fluid aperture located on a portion of the wall of the second piercing member facing away from the first piercing member.

In accordance with a second aspect of the invention there is provided a microfluidic diagnostic system comprising: a microfluidic cassette according to the first aspect; and a microfluidic diagnostic device adapted to receive the microfluidic cassette, the microfluidic diagnostic device comprising one or more actuators adapted to break the seal of a reagent-containing chamber of an insert of the microfluidic cassette.

Advantageously, in accordance with embodiments of the invention, there is provided a microfluidic cassette arrangement that enables reagent to be protected in a sealed chamber prior to use, thereby preventing external materials from contacting and potentially degrading the reagent, while also ensuring that during a diagnostic test, a fluid sample can flow through the chamber in a regular and controllable manner and with adequate mixing of the fluid sample with reagent contained in the chamber.

The microfluidic cassette includes first and second piercing members each comprising a wall extending out from the microfluidic cassette body, the walls enclosing respective fluid apertures that are in fluid communication with a fluid flow channel of the microfluidic cassette. The first piercing member comprises a further fluid aperture located on a portion of the wall of the first piercing member facing away from the second piercing member. In this way, relative to the second piercing member, the further fluid aperture is located on the back of the first piercing member. Fluid passing through the further fluid aperture travels in a direction away from the second piercing member.

In certain embodiments, the further fluid aperture is located immediately adjacent to the distal end of the wall of the first piercing member. In such embodiments, the further fluid aperture and the aperture formed by the walls of the first piercing member at the distal end of the first piercing member together form a larger aperture.

The further fluid aperture in the first piercing member provides a region in the first piercing member where material is not present. In use, when the first piercing member is engaged with a reagent containing chamber, the further fluid aperture provides a further path for fluid to flow into or out of the reagent-containing chamber. This enables fluid to flow through the reagent-containing chamber even if the end of the piercing member is partially or fully blocked, for example due to the seal of the reagent chamber partially or fully overlying the distal end of the piercing member.

Additionally, the location of the further fluid aperture on the portion of the wall of the first piercing member that faces away from the second piercing member improves mixing of the fluid sample with the reagent contained in the reagent-containing chamber. The location of the further fluid aperture ensures that the fluid sample follows a path through the reagent-containing chamber that results in improved mixing of the fluid sample with reagent.

This can help avoid fluid bypassing some or all of the reagent, for example by passing through the shallowest part of the chamber along the surface of the microfluidic cassette without fully mixing with the reagent in the chamber.

In certain embodiments, both the first and second piercing members can include a further aperture configured as described herein. Providing a further aperture in both piercing members can further improve fluid flow and reagent mixing.

Advantageously, in certain embodiments, the distal ends of the piercing members can be sloped. In this way, in use some parts of the distal ends of the piercing members extend further into a reagent-containing chamber. In such embodiments, the further aperture can be located on or close to the “tip” of the sloped distal end of one or both of the piercing members. Advantageously, combining the sloped distal end and the further aperture located on the tip of the slope can further improve the ability of the annular wall to effectively pierce the seal of a chamber while also providing desirable fluid flow characteristics through the chamber.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a simplified schematic diagram of a microfluidic diagnostic system in accordance with certain embodiments of the invention;

FIG. 2a shows an outer surface of a portion of a microfluidic cassette in accordance with certain embodiments of the invention;

FIG. 2b shows a further view of the microfluidic cassette of FIG. 2a;

FIG. 3 shows a cross sectional view of an insert in accordance with certain embodiments of the invention;

FIG. 4 shows a cross sectional view of a cover element in accordance with certain embodiments of the invention; and

FIGS. 5a-5d provide cross-sectional views of an assembled cassette arrangement within a microfluidic diagnostic device.

### DETAILED DESCRIPTION

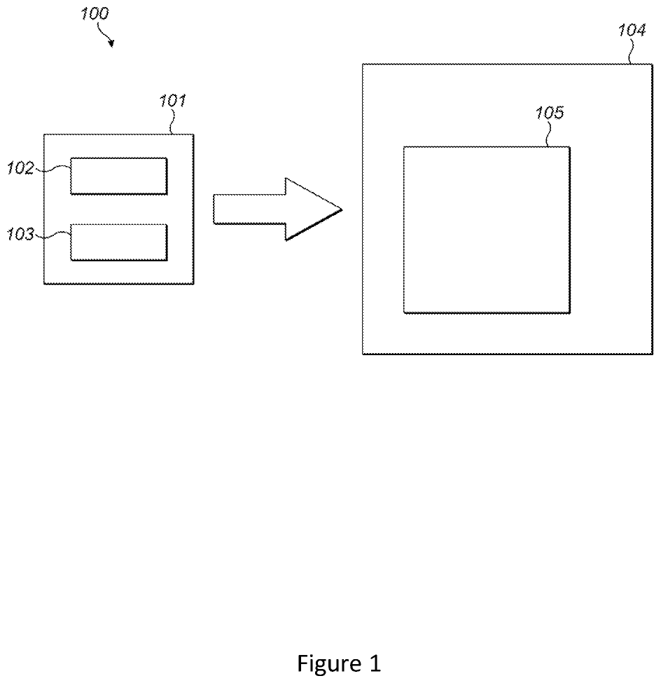

FIG. 1 provides a simplified schematic diagram of a microfluidic diagnostic system 100 in accordance with certain embodiments of the invention. The system 100 comprises a microfluidic cassette 101 comprising a microfluidic cassette body 102 and at least one chamber 103. The microfluidic cassette 101 can be of a type described in more detail herein.

The system 100 further comprises a microfluidic diagnostic device 104 adapted to receive the cassette 101. The diagnostic device 104 comprises a cassette receiving region that allows the cassette 101 to be inserted into the diagnostic device 104. The diagnostic device 104 further comprises components that enable it to interact with the cassette 101 to perform diagnostic tests on a fluid sample contained in the cassette 101. For example, the diagnostic device 104 can comprise one or more diagnostic sensing and/or imaging components for conducting diagnostic sensing and/or imaging on a fluid sample contained in the cassette 101. The diagnostic device 104 may also comprise components for heating and/or cooling the fluid sample.

The diagnostic device 104 comprises one or more actuators 105. The one or more actuators 105 are adapted to break a seal of a chamber of the cassette 101 in situ as described in more detail below.

In use the cassette 101 is inserted into the diagnostic device 104 (denoted by large arrow). After the cassette 101 has been inserted into the diagnostic device 104 the seal of the chamber 103 is broken in situ via the one or more actuators 105. A fluid sample is then introduced into a fluid flow channel of the cassette 101 and diagnostic testing is performed on the sample.

The one or more actuators 105 can comprise one or more moveable actuating members. The actuating members are moveable from a position where they are not in contact with the microfluidic cassette 101 into a position where they are in contact with the microfluidic cassette 101. The actuating members may, after the cassette 101 has been inserted into the diagnostic device 104, apply a force to part of the cassette 101 to break the seal of the chamber 103 in situ.

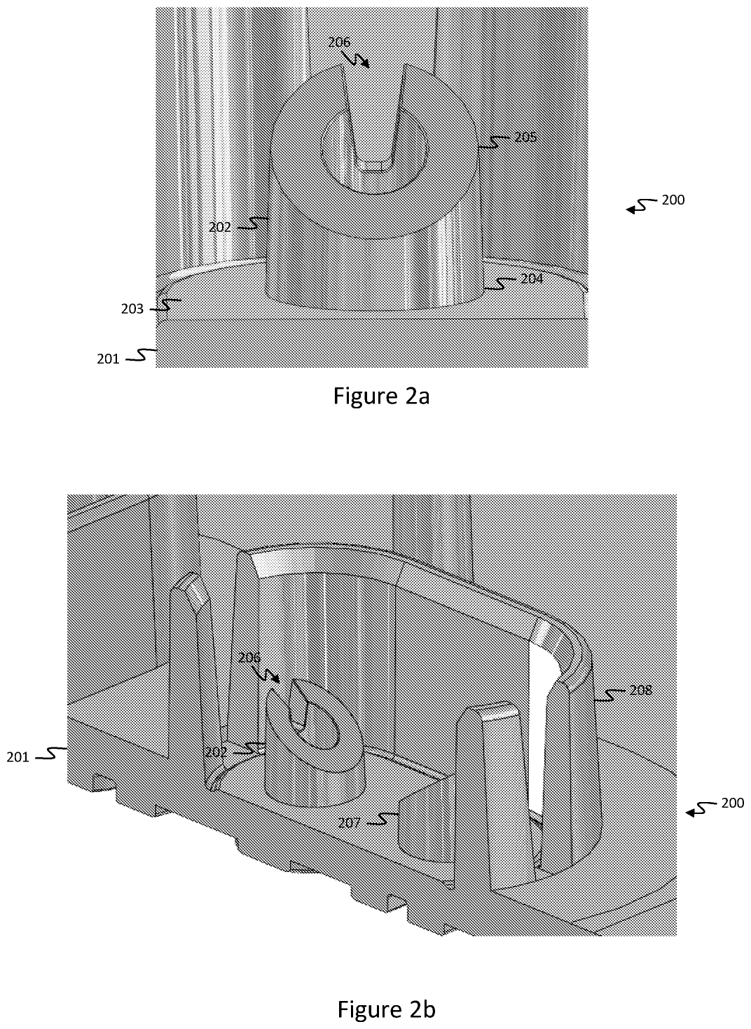

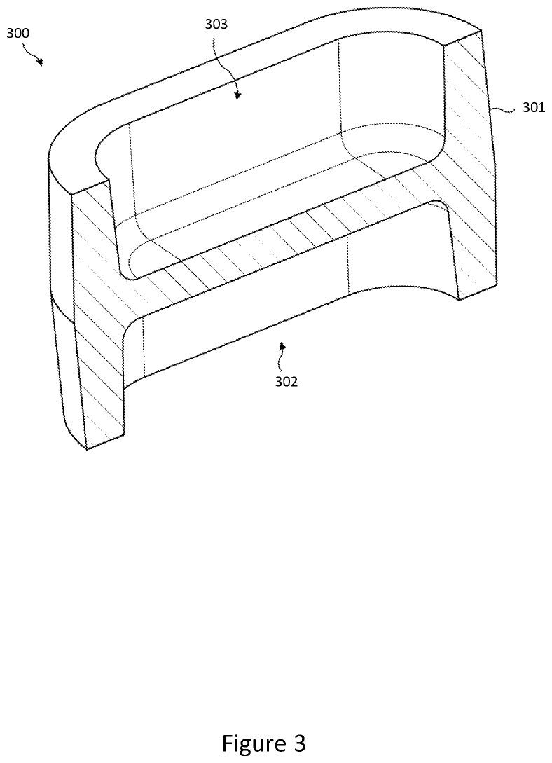

FIG. 2a shows an outer surface of a portion of a microfluidic cassette 200 in accordance with certain embodiments of the invention. The microfluidic cassette 200 can be of a type described with reference to FIG. 1. The microfluidic cassette 200 includes a microfluidic cassette body 201. As will be understood, the microfluidic cassette body 201 includes one or more fluid flow channels that enable a liquid fluid sample, typically provided by a patient, to pass through the microfluidic cassette 200 as a diagnostic assay is performed on the sample.

The microfluidic cassette body 201 includes a first piercing member 202. The first piercing member 202 is hollow. In this embodiment, the first piercing member 202 is an annular wall that extends out from a surface 203 of the microfluidic cassette body 201. The first piercing member 202 includes a proximal end 204 located immediately adjacent to the surface 203 and a distal end 205 located away from the surface 203.

The first piercing member 202 encloses an aperture (not shown) in the surface 203 of the microfluidic cassette body 201. The aperture is in fluid communication with the fluid flow channel of the microfluidic cassette 200. In this way, a fluid flow passageway is formed from the fluid flow channel of the cassette into the hollow inner region of the first piercing member 202.

In use, the distal end 205 is arranged to puncture a breakable seal of a reagent-containing chamber.

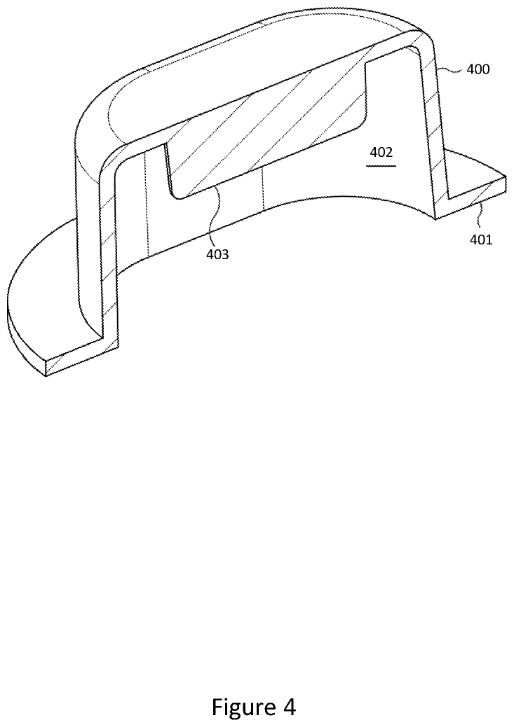

More particularly, the microfluidic cassette body 201 is arranged to provide an interface with an insert such as an insert of the type described with reference to FIG. 3. Such an insert includes a sealed reagent-containing chamber. As the insert is moved towards the first piercing member 202, the first piercing member 202 pierces the seal of the reagent containing chamber. Subsequently, a fluid flow passageway is formed between the reagent-containing chamber and the fluid flow channel of the cassette via the hollow inner region of the first piercing member 202 and the aperture that the first piercing member 202 encloses. This allows a fluid sample to flow through the reagent-containing chamber and mix with reagent contained within the chamber.

In this embodiment, the distal end 205 of the first piercing member 202 is sloped such that part of the distal end 205 extends further from the surface 203. The slope is continuous around the circumference of the distal end 205 and follows a plane offset from the surface 203 of the microfluidic cassette body 201. The slope of the distal end 205 improves the ability of the first piercing member 202 to puncture a seal.

The first piercing member 202 includes a further fluid aperture 206. The further fluid aperture 206 provides a further path for fluid to flow out of the first piercing member 202 (that is, in addition to flowing out of the distal end 205). This enables fluid to flow through the reagent-containing chamber even if the end of the end of the first piercing member 202 is partially or fully blocked, for example due to part of the seal partially or fully overlying the distal end 205 of the piercing member 202 after the seal has been pierced.

In this embodiment, the fluid aperture 206 is a slot. The slot is an elongate region of the first annular wall 202 where no material is present. The slot begins at the distal end 205 and extends partially through the piercing member in the direction of the proximal end 204. The slot is substantially V-shaped. The slot is wider at the distal end 205 and narrows in the direction of the proximal end 204.

In this embodiment, the further fluid aperture 206 is located on or close to the part of the first piercing member 202 that is furthest from the surface 203 of the microfluidic cassette body 201. In this embodiment, the part of the first piercing member 202 that is furthest from the surface 203 of the microfluidic cassette body 201 is the tip of the sloped distal end 205. By locating the further fluid aperture 206 in this position, the further 206 fluid aperture is located on the part of the first piercing member 202 that, in use, extends furthest into a reagent-containing chamber. This improves the flow of fluid through the reagent-containing chamber.

Locating the further fluid aperture 206 on the tip of the sloped distal end of the first piercing member 202 can further improve the ability of the first piercing member 202 to effectively pierce the seal of a chamber while also ensuring desirable fluid flow characteristics through the chamber.

In this embodiment, the further fluid aperture 206 is located immediately adjacent to the distal end 205 of the wall of the first piercing member 202. In such embodiments, the further fluid aperture and the aperture formed by the walls of the first piercing member at the distal end of the first piercing member together form a larger aperture.

FIG. 2b shows a further view of the microfluidic cassette 200 of FIG. 2a. In addition to the first piercing member 202, the microfluidic cassette body 201 includes a second piercing member 207. The second piercing member 207 substantially corresponds with the first piercing member 202 and includes a further fluid aperture that substantially corresponds with the further fluid aperture 206 of the first piercing member 202.

As best shown in FIG. 2b, the further fluid aperture 206 of the first piercing member 202 is located on the part of the wall of the first piercing member 202 that faces away from the second piercing member 207. In this way, relative to the second piercing member 207, the further fluid aperture 206 is located on the back of the first piercing member 202.

The further fluid aperture 206 is located such that it is pointing away from the second piercing member 207. In this way, the further fluid aperture 206 is located on the first piercing member 202 at a point that is at or close to the part of the first piercing member 202 that is furthest in distance from the second piercing member 207. Fluid passing through the further fluid aperture 206 travels in a direction away from the second piercing member 207.

Similarly, the second piercing member 207 includes a further fluid aperture (not shown) that is located on the part of the wall of the second piercing member 207 that faces away from the first piercing member 202. Relative to the first piercing member 202, the further fluid aperture of the second piercing member 207 is located on the back of the second piercing member 207.

The location of the further fluid apertures improves mixing of the fluid sample with reagent contained in a reagent-containing chamber. This is because the location of the further fluid apertures ensures that the fluid sample follows a path through the reagent-containing chamber that results in improved mixing of the fluid sample with reagent. In particular, this arrangement can help avoid the fluid sample bypassing some or all of the reagent in the chamber by passing through the shallowest part of the chamber (i.e. the part closest to the surface 203 of the cassette body 201) without fully mixing with the reagent in the chamber.

The microfluidic cassette body 201 also includes an outer wall 208. The outer wall 208 encloses the first and second piercing members 202, 207 and acts as a guide for movement of an insert towards and away from the first and second piercing members 202, 207.

It will be understood that in certain embodiments, either the first or the second piercing member 202, 207, or both of the first and second piercing members 202, 207, can include a further fluid aperture configured as described herein.

In this embodiment, the first and second piercing members 202, 207 are substantially annular in shape. However, it will be understood that in other embodiments other suitable shapes can be used.

In this embodiment, the distal end of both piercing members 202, 207 is substantially sloped. However. In other embodiments, the distal ends 205 of either or both of the piercing members can be substantially flat.

In this embodiment, the further aperture is a slot. However, it will be understood that in other embodiments, the further aperture can take another suitable form such as a through-hole.

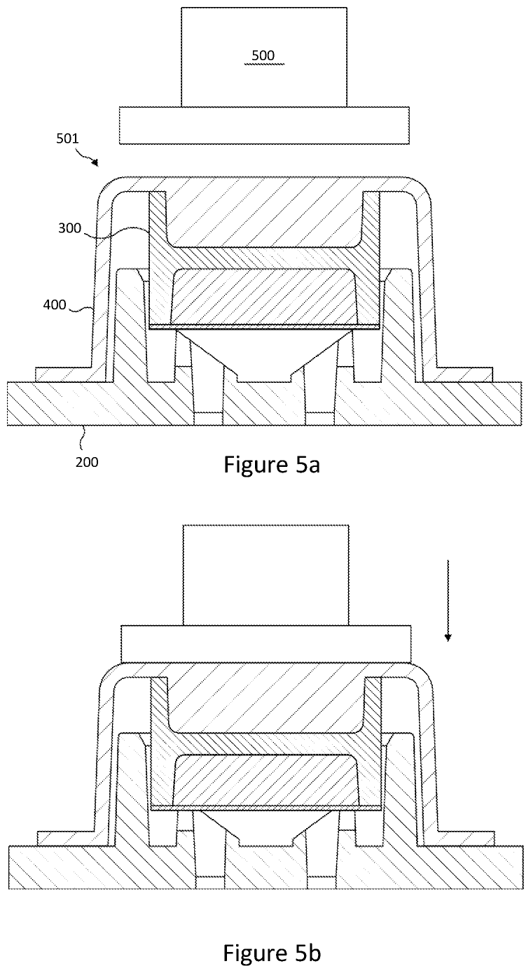

FIGS. 3 and 4 show further components that can be provided as part of a microfluidic cassette arrangement that includes the microfluidic cassette described with reference to FIGS. 2a and 2b.

FIG. 3 provides a diagram showing a cross sectional view of an insert according to certain embodiments of the invention.

The insert 300 includes a body 301. The body 301 includes a first enclosed region 302. Prior to use, the first enclosed region 302 is filled with reagent and is sealed to provide a reagent-containing chamber.

The term reagent is used herein to refer to a substance or mixture for use in chemical analysis or other reactions. In certain embodiments the reagent may be a dried or lyophilised substance. In certain embodiments the reagent may be a liquid or gas.

The body 301 also includes a second enclosed region 303. In this embodiment, the second enclosed region 303 is located opposite to and substantially corresponds in shape with the first enclosed region 302 such that the body 301 has a substantially H-shaped cross section. The second enclosed region 303 can be used to secure the insert 300 to another structure, such as the cover described with reference to FIG. 4.

After the first enclosed region 302 is filled with reagent to provide a reagent-containing chamber, a seal (not shown) is provided to seal the reagent within the chamber.

In certain embodiments, the seal is composed of a foil (for example, comprising aluminium), a thermoplastic or a polypropylene (PP) foil composite material. Typically, the seal is secured (i.e. sealed) via heat-staking, laser welding or by using a suitable adhesive such as a thin adhesive. In certain embodiments, the seal has a thickness of approximately 20 microns. The seal is breakable when a mechanical piercing force is applied to the seal.

FIG. 4 is a diagram showing a cross sectional view of a cover element in accordance with certain embodiments of the invention.

The cover element 400 is arranged to be secured via a fluid impermeable seal to form part of a microfluidic cassette body. The cover element 400 is typically sealed at an end portion 401 to provide an inner chamber 402. The cover element 400 is shaped so that it can enclose a region of the cassette body and an insert such as an insert of the type described with reference to FIG. 3.

The cover element 400 is resiliently deformable. Typically, the cover element 400 is composed of a material such as a thermoplastic elastomer.

The cover element 400 is arranged so that an insert can be secured to an inside surface of the cover element 400. In this embodiment, the cover element 400 includes a region 403 that is shaped to correspond with the shape of part of an insert to provide a friction fit between the cover element 400 and the insert.

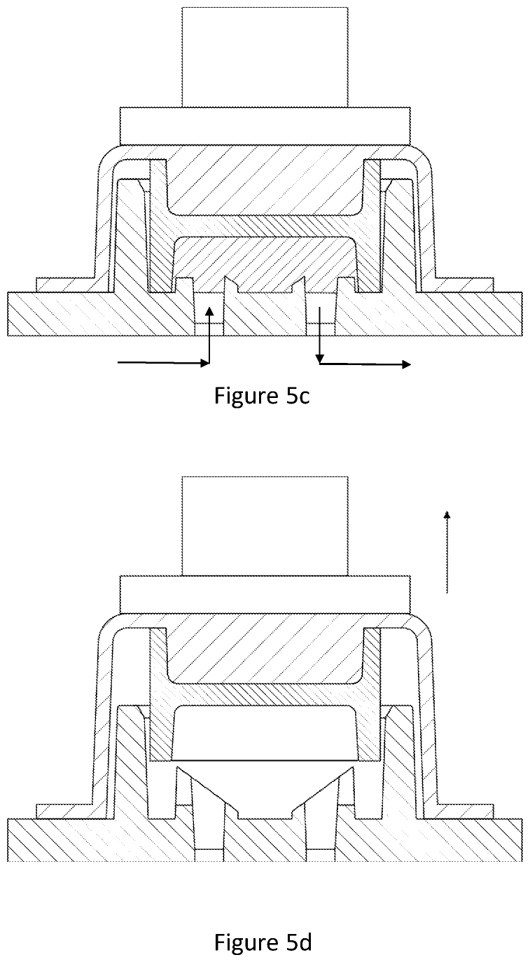

A microfluidic cassette arrangement 501 will now be described in use with reference to FIGS. 5a-5d in accordance with embodiments of the invention.

FIGS. 5a-5d provide a cross-sectional view of an assembled cassette arrangement 501 in use after being inserted into a microfluidic diagnostic device. The cassette arrangement 501 includes the microfluidic cassette 200, insert 300, and cover element 400 described with reference to FIGS. 2, 3 and 4 respectively. For clarity, some reference signs have been omitted from FIGS. 5a to 5d.

FIG. 5a shows the cassette arrangement 501 prior to use. A moveable actuating member 500 of the microfluidic diagnostic device is also shown in FIG. 5a.

The insert 300 has been secured to the inside surface of the cover element 400 and the cover element 400 has been sealed to the remainder of the cassette body 200.

The insert 300 is initially in a first position, shown in FIG. 5a, in which it is not in contact with the piercing members and before the seal has been broken.

Next, the moveable actuating member 500 is moved towards the cover element 400. The actuating member 500 makes contact with and begins to displace the cover element 400 and insert 300 towards the cassette body 200. The direction of movement of the cover element 400 and insert 300 towards the cassette body 200 is guided by the outer wall of the cassette body 200 making contact with the insert 300

As the insert 300 is moved, the piercing members of the cassette body 200 make contact with and pierce the seal of the insert 300. This is shown in FIG. 5b.

The actuating member 500 continues to displace the cover element 400 and insert 300 towards the cassette body 200 until it reaches a second position wherein the insert 300 makes contact with the cassette body 200. This is shown in FIG. 5c

In this configuration, the insert 300 is sealed against the cassette body 200 and the reagent-containing chamber of the insert 300 is in fluid communication with a fluid flow channel of the microfluidic cassette via the fluid apertures of the cassette body 200.

In this configuration, microfluidic tests can be performed by the microfluidic diagnostic device in which fluid flows through the insert 300 and interacts with reagent contained therein.

FIG. 5c includes arrows representing an example fluid flow of a fluid sample passing into and out from the chamber of the insert 300 during a microfluidic test. In certain embodiments, during different stages of a diagnostic test, fluid can flow in either direction through the chamber.

As described herein, in certain implementations, when the seal is pierced by the piercing members, the seal can often partially or fully occlude the ends of the piercing members. As described herein, the presence of the further apertures in the sides of one or both of the piercing members provides a further fluid flow passageway for a fluid sample to enter the chamber by bypassing the ends of the piercing members. This enables the fluid sample to pass through the insert even when the ends of the piercing members are blocked. Further, the location of the further apertures can improve the mixing of a fluid sample with reagent in the chamber by increasing the distance that the fluid needs to travel between the first and second piercing members and preventing the fluid sample from bypassing the portion of the chamber further from the surface of the cassette body (i.e., the “deeper” portion of the chamber) where the majority of reagent is typically present.

After a diagnostic test has finished, the actuating member 500 moves away from the cassette body 200, as shown in FIG. 10d. Due to the resilience of the cover element 400, this causes the cover element 400 to return to its original shape, thereby also moving the insert 300 away from the cassette body 200.

Due to the fluid impermeable seal between the cover element 400 and the cassette body 300, the cassette remains sealed throughout and fluid is prevented from leaking out of the inside of the cassette.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A microfluidic cassette comprising:
a microfluidic cassette body, the microfluidic cassette body comprising:
a fluid flow channel;
a first piercing member comprising a wall extending out from the microfluidic cassette body, the wall enclosing a first fluid aperture that is in fluid communication with the fluid flow channel; and
a second piercing member comprising a wall extending out from the microfluidic cassette body and adjacent to the first piercing member, the wall enclosing a second fluid aperture that is in fluid communication with the fluid flow channel,
wherein the first piercing member comprises a further fluid aperture located on a portion of the wall of the first piercing member facing away from the second piercing member.

2. The microfluidic cassette of claim 1, wherein the further fluid aperture is a slot in the wall of the first piercing member.

3. The microfluidic cassette of claim 2, wherein the slot extends through the wall in a direction from a distal end of the wall towards a proximal end of the wall.

4. The microfluidic cassette of claim 3, wherein the slot is substantially V-shaped and decreases in width in a direction from the distal end of the wall towards the proximal end of the wall.

5. The microfluidic cassette of claim 1, wherein the further fluid aperture is located on the wall at or close to a portion of the wall that extends furthest from the microfluidic cassette body.

6. The microfluidic cassette of claim 1, wherein one or both of the wall of the first piercing member and and/or the wall of the second piercing member are substantially annular.

7. The microfluidic cassette of claim 1, wherein one or both of a distal end of the wall of the first piercing member and a distal end of the wall of the second piercing member are substantially sloped.

8. The microfluidic cassette of claim 1, further comprising an insert comprising a reagent-containing chamber, wherein the reagent-containing chamber comprises a seal pierceable by the first and second piercing members.

9. The microfluidic cassette of claim 8, wherein the insert is secured within the microfluidic cassette body and is movable from a first position within the microfluidic cassette body where the seal of the reagent-containing chamber is not in contact with the first and second piercing members to a second position within the microfluidic cassette body where the seal is in contact with the first and second piercing members.

10. The microfluidic cassette of claim 9, wherein the microfluidic cassette body further comprises an outer wall enclosing the first and second piercing members, the outer wall shaped to guide movement of the insert between the first position and the second position.

11. The microfluidic cassette of claim 8, further comprising a cover element arranged to provide a sealed chamber enclosing the first and second piercing members and the insert.

12. The microfluidic cassette of claim 11, wherein the insert is secured to an inner surface of the cover element.

13. The microfluidic cassette of claim 1, wherein the second piercing member comprises a further fluid aperture located on a portion of the wall of the second piercing member facing away from the first piercing member.

14. A microfluidic diagnostic system comprising:
a microfluidic cassette according to claim 1; and
a microfluidic diagnostic device adapted to receive the microfluidic cassette, the microfluidic diagnostic device comprising one or more actuators adapted to break a seal of a reagent-containing chamber of an insert of the microfluidic cassette.
